(19) United States
(12) Patent Application Publication
(10) Pub. No.: US 2026/0327837 A1
(43) Pub. Date: Oct. 22, 2026

(54) Method for Manufacturing Smart Window

(71) Applicant: Ming Chi University of Technology, New Taipei City (TW)

(72) Inventors: Tsung-Yu Huang, New Taipei City (TW); Cheng-Yuan Xiao, New Taipei City (TW)

(21) Appl. No.: 19/278,887

(22) Filed: Jul. 24, 2025

(30) Foreign Application Priority Data
Apr. 21, 2025 (TW) 114115018

(51) Int. Cl. C25D 5/02; C25D 5/56; E06B 9/24

(52) U.S. Cl. CPC C25D 5/022; C25D 5/56; E06B 2009/2464

(57) ABSTRACT

A method for manufacturing a smart window includes forming a mask layer on a surface of a transparent substrate, the mask layer including etched nanospheres not in contact with one another and arranged in an array; performing a deposition treatment on the surface of the transparent substrate through the mask layer to form a conductive layer formed with nanopores that correspond in positions to the etched nanospheres and that partially expose the surface of the transparent substrate; removing the mask layer to form a conductive composite substrate; and performing a first electrochemical treatment on the conductive composite substrate to form a silver plating layer which covers the conductive composite substrate, the silver plating layer being capable of undergoing a reduction-oxidation reaction in a second electrochemical treatment such that the silver metals are transformed into the silver ions and vice versa.

### CROSS-REFERENCE TO RELATED APPLICATION

This application claims priority to Taiwanese Patent Application No. 114115018 filed Apr. 21, 2025, the disclosure of which is hereby incorporated by reference in its entirety.

### BACKGROUND OF THE DISCLOSURE

### Field of the Disclosure

The disclosure relates to a window, and more particularly to a method for manufacturing smart window.

### Description of Related Art

At present, smart windows, based on different chromic mechanisms thereof, can be generally categorized into photochromic smart windows, thermochromic smart windows and electrochromic smart windows. The photochromic smart windows change transmittances thereof through exposure to sunlight, so additional application of external energy thereon is not required. However, the photochromic smart windows cannot be used in regions with insufficient sunlight, such that availability thereof is limited by the use environments therefor, and a long time period is required for restoring the transmittances of the photochromic smart windows to initial values after photochromism. The thermochromic smart windows change transmittances thereof through changes in environmental temperature, so additional application of external energy thereon is not required. However, the thermochromic smart windows cannot be used in cold regions, such that availability of the thermochromic smart windows is limited by the use environments therefor. Moreover, since an excitation source (i.e. a light source) of the photochromic smart windows and an excitation source (i.e., a heat source) of the thermochromic smart windows cannot be controlled, the transmittances of the photochromic smart windows and the thermochromic smart windows can only be sustained at one of two extreme transmittance values (i.e., a transmittance value obtained without the excitation source and a transmittance value obtained with the excitation source) and cannot be controlled to be at a specific transmittance value. The electrochromic smart windows change transmittances thereof through voltage applications, so that use environments therefor are less restricted as long as power supplies are provided, and only a short time period is required for restoring the transmittances of the eletrochromic smart windows to initial values after electrochromism. In addition, the transmittances of the electrochromic smart windows can be fixed at a specific value, so the transmittances of the electrochromic smart windows can be controlled to be at an arbitrary value. However, the electrochromic smart windows require continuous application of voltage, and thus energy consumptions are greater. Therefore, the abovementioned smart windows all have respective and different shortcomings.

Based on the above, those skilled in the art strives to manufacture a smart window with great availability, great convenience and low energy consumption.

SUMMARY OF THE DISCLOSURE

Therefore, an object of the disclosure is to provide a method for manufacturing a smart window that can alleviate at least one of the drawbacks of the prior art.

According to the disclosure, a method for manufacturing a smart window includes the steps of:
forming a mask layer on a surface of a transparent substrate, the mask layer including etched nanospheres which are not in contact with one another and which are arranged in an array;
performing a deposition treatment on the surface of the transparent substrate through the mask layer so as to form a conductive layer on the surface of the transparent substrate, the conductive layer being formed with nanopores which correspond in positions to the etched nanospheres and which partially expose the surface of the transparent substrate;
removing the mask layer so as to form a conductive composite substrate which includes the transparent substrate and the conductive layer; and
performing a first electrochemical treatment on the conductive composite substrate so as to form a silver plating layer which covers the surface of the transparent substrate and the conductive layer, the silver plating layer including silver metals and silver ions, the silver plating layer being capable of undergoing a reduction-oxidation reaction in a second electrochemical treatment such that the silver metals are transformed into the silver ions or the silver ions are transformed into the silver metals, so as to obtain a dynamically tunable smart window.

### DESCRIPTION OF THE NON-LIMITING EMBODIMENTS OF THE DISCLOSURE

The disclosure provides a manufacturing method of a smart window which includes the steps of: a) forming a mask layer on a surface of a transparent substrate; b) performing a deposition treatment on the surface of the transparent substrate through the mask layer so as to form a conductive layer on the surface of the transparent substrate; c) removing the mask layer so as to form a conductive composite substrate which includes the transparent substrate and the conductive layer; and d) performing a first electrochemical treatment on the conductive composite substrate so as to form a silver plating layer which covers the surface of the transparent substrate and the conductive layer. In step a), the mask layer includes etched nanospheres which are not in contact with one another and which are arranged in an array. In step b), the conductive layer is formed with nanopores which correspond in positions to the etched nanospheres and which partially expose the surface of the transparent substrate. In step d), the silver plating layer includes silver metals and silver ions. In step d), the silver plating layer is capable of undergoing a reduction-oxidation reaction in a second electrochemical treatment such that the silver metals are transformed (e.g., oxidized) into the silver ions or the silver ions are transformed (e.g., reduced) into the silver metals, so as to obtain the dynamically tunable smart window.

In some embodiments of the disclosure, the transparent substrate includes a glass substrate or a transparent flexible substrate. In some embodiments of the disclosure, the transparent flexible substrate includes a polyimide (PI) film, a polyethylene terephthalate (PET) film, or a combination thereof.

In some embodiments of the disclosure, in order to provide the transparent substrate with a better hydrophilicity, the method of the disclosure further includes performing a first etching treatment on the surface of the transparent substrate before formation of the mask layer on the surface of the transparent substrate in step a). In some embodiments of the disclosure, the first etching treatment is performed by subjecting the surface of the transparent substrate to, for example, but not limited to, reactive ion etching. Reactive ions used in the reactive ion etching of the first etching treatment include or are, for example, but not limited to, oxygen ions. Moreover, conditions of the reactive ion etching adopted in the first etching treatment are not specifically limited and may be adjusted arbitrarily according to practical demands. In some embodiments of the disclosure, the reactive ion etching of the first etching treatment is performed at a power ranging from 50 W to 300 W, an oxygen flow rate ranging from 50 sccm to 200 sccm, and an etching time period ranging from 30 seconds to 180 seconds.

In some embodiments of the disclosure, step a) of forming the mask layer includes sub-steps of: a1) forming a coating layer on the surface of the transparent substrate; and a2) performing a second etching treatment on the coating layer so that the coating layer is formed into the mask layer. In sub-step a1), the coating layer includes primitive nanospheres which are in contact with one another and which are arranged in an array.

Specifically, a nanosphere dispersion with the primitive nanospheres is used in sub-step a1), and is spin-coated on the surface of the transparent substrate to form the coating layer. In some embodiments of the disclosure, the primitive nanospheres include a polystyrene nanosphere, a silicon nanosphere, or a combination thereof. When the nanosphere dispersion is spin-coated on the surface of the transparent substrate, the primitive nanospheres in the nanosphere dispersion are arranged in an array through self-assembly and are in close contact with one another. More specifically, the primitive nanospheres are formed into the coating layer in an arrangement form of a close-packed plane. In some embodiments of the disclosure, a three-staged spin coating process is used to coat the nanosphere dispersion on the surface of the transparent substrate. A rotational speed of a first stage of the three-staged spin coating process ranges from 300 rpm to 800 rpm. A rotational speed of a second stage of the three-staged spin coating process ranges from 1000 rpm to 2000 rpm. A rotational speed of a third stage of the three-staged spin coating process ranges from 2500 rpm to 4000 rpm. As such, the nanosphere dispersion may be more uniformly coated on the surface of the transparent substrate.

In sub-step a2), during the second etching treatment, diameters of the primitive nanospheres are adjusted to decrease the diameters thereof, so that the coating layer, which includes the primitive nanospheres that are in contact with one another, is formed into the mask layer which includes the etched nanospheres that are not in contact with one another. In some embodiments of the disclosure, the second etching treatment is performed by subjecting the primitive nanospheres to, for example, but not limited to, reactive ion etching. Reactive ions used in the reactive ion etching of the second etching treatment include or are, for example, but not limited to, the oxygen ions. Moreover, conditions of the reactive ion etching adopted in the second etching treatment are not specifically limited and may be adjusted arbitrarily according to practical demands. In some embodiments of the disclosure, in order to form the etched nanospheres with appropriate dimensions such that the conductive layer has an appropriate conductivity, and thus being conducive to enhancing a transmittance change of the smart window, the reactive ion etching of the second etching treatment is performed at a power ranging from 50 W to 150 W, an oxygen flow rate ranging from 50 sccm to 100 sccm, and an etching time period ranging from 30 seconds to 90 seconds.

In some embodiments of the disclosure, after performing the first etching treatment on the surface of the transparent substrate, the coating layer is formed, followed by performing the second etching treatment so as to form the mask layer. More specifically, after the first etching treatment is performed on the surface of the transparent substrate, the coating layer is formed on the surface of the transparent substrate, and then is subjected to the second etching treatment so that the coating layer is formed into the mask layer.

In some embodiments, the etched nanospheres are formed from the primitive nanospheres. Therefore, types of the etched nanospheres depend on types of the primitive nanospheres. That is, in some embodiments of the disclosure, the etched nanospheres include a polystyrene nanosphere, a silicon nanosphere, or a combination thereof. Furthermore, diameters of the etched nanospheres are smaller than the diameters of the primitive nanospheres.

In some embodiments of the disclosure, a conductive material is used in the deposition treatment to form the conductive layer. The conductive material includes gold, silver, aluminum, indium tin oxide, or combinations thereof. In some embodiments, an initial value of the transmittance of the smart window is adjusted through selection of the conductive material. As the initial value of the transmittance of the smart window increases, the smart window has a higher change in the transmittance. Conditions of the deposition treatment are not specifically limited and may be adjusted arbitrarily according to practical demands on the conductive layer. In some embodiments of the disclosure, in order to maintain the conductivity of the conductive layer at a certain degree and to increase the initial value of the transmittance of the smart window so as to increase the change of the transmittance, a thickness of the conductive layer is greater than 0 nm and not greater than 20 nm.

In the disclosure, since the etched nanospheres of the mask layer are not in contact with one another and are arranged in an array, the conductive layer, which is formed through the mask layer in the deposition treatment, is continuously formed on the surface of the transparent substrate. Moreover, since the conductive layer, which is formed through the mask layer, is formed with the nanopores, the conductivity of the conductive layer is provided without blocking lights from passing through the transparent substrate, thereby facilitating subsequent control of chromism of the smart window.

In some embodiments of the disclosure, the mask layer is removed by using toluene.

In the disclosure, the silver plating layer is used to control the transmittance of the lights passing through the transparent substrate, that is, to control chromism or fading of the smart window. After manufacturing of the smart window, the silver metals of the silver plating layer are oxidized into the silver ions by applying a positive voltage on the silver plating layer, so that the silver plating layer is thinned. The thinner the silver plating layer is, the lower the coverage area of the silver plating layer on the nanopores of the conductive layer is, that is, the lower the coverage area of the surface of the transparent substrate which is exposed from the nanopores is, thereby enhancing the transmittance of the lights passing through the transparent substrate. The silver ions of the silver plating layer are reduced into the silver metals by applying a negative voltage on the silver plating layer. The silver metal is deposited so that the silver plating layer is thickened. The thicker the silver plating layer is, the higher the coverage area of the silver plating layer on the nanopores of the conductive layer is, that is, the higher the coverage area of the surface of the transparent substrate which is exposed from the nanopores is, thereby reducing the transmittance of the lights passing through the transparent substrate.

In some embodiments of the disclosure, when gold is used as the conductive material, the smart window has an initial value of a transmittance of visible light of 62%, and has a final value of the transmittance of the visible light of 0% after the silver plating layer is formed on the conductive layer; the smart window has an initial value of a transmittance of infrared light of 0%, and has a final value of the transmittance of the infrared light of 0% after the silver plating layer is formed on the conductive layer. Since the initial value and the final value of the transmittance of the infrared light are both 0%, a room temperature of a place where the smart window is used can be decreased.

In the disclosure, the first electrochemical treatment for forming the silver plating layer is not specifically limited and may be adjusted arbitrarily according to a required thickness of the silver plating layer. In some embodiments of the disclosure, the first electrochemical treatment for forming the silver plating layer is performed by immersing the conductive composite substrate into an electrolyte of silver nitrate or an electrolyte of silver cyanide, and applying a constant voltage. The applied constant voltage may range, for example, from 0.05 V to 5 V, but is not limited thereto, and a time period of applying the constant voltage may be, for example, greater than 0 minute and not greater than 10 minutes, but is not limited thereto, i.e., the time period may be adjusted according to practical demands.

In some embodiments, the smart window further includes another transparent substrate which is not etched and which is disposed on the conductive composite substrate with an electrolyte (e.g., silver nitrate) being filled between the another transparent substrate and the conductive composite substrate. Specifically, the another transparent substrate is disposed on the silver plating layer which is formed on the conductive layer of the conductive composite substrate, and the electrolyte (e.g., silver nitrate) is filled to be in contact with the silver plating layer. Therefore, when a certain voltage is applied on the silver plating layer, the silver metals are oxidized to form the silver ions which then exist in the electrolyte (e.g., silver nitrate), or the silver ions in the electrolyte (e.g., silver nitrate) are reduced to form the silver metals.

Specifically, the coverage area of the silver plating layer on the surface of the transparent substrate and the conductive layer of the smart window, which is manufactured by the aforementioned method, is determined by adjusting the voltage applied on the silver plating layer, so as to control the transmittance of the smart window. Furthermore, the coverage area of the silver plating layer on the surface of the transparent substrate and the conductive layer depends on a transformation between the silver metals and the silver ions in the reduction-oxidation reaction after the voltage is applied on the silver plating layer. In addition, when the voltage applied on the silver plating layer is ceased, the transformation between the silver metals and the silver ions stopped, so that the coverage area of the silver plating layer on the surface of the transparent substrate and the conductive layer is maintained at a certain state. That is, the transmittance of the smart window is stably fixed at a constant value simply by applying the voltage on the silver plating layer. When the transmittance of the smart window reaches a predetermined value, the voltage applied on the silver plating layer may be ceased by a user, which implies that the transmittance is fixed at the constant value without applying additional voltage on the silver plating layer. Moreover, by means of a characteristic of the transformation between the silver metals and the silver ions, the smart window may switch between a chromism state (with a lower transmittance) and a fading state (with a higher transmittance) rapidly in a short time period. Based on the voltage applied on the silver plating layer, the smart window manufactured by the aforementioned method may be switched from the fading state to the chromism state within 3 seconds at the fastest speed and from the chromism state to the fading state within 10 seconds at the fastest speed.

In summary, in the method for manufacturing the smart window according to the disclosure, the mask layer is formed on the transparent substrate, and the conductive layer with the nanopores is formed on the transparent substrate through the mask layer so as to form the conductive composite substrate. Therefore, by means of manufacturing the smart window with the conductive composite substrate and the silver plating layer, the transmittance of the smart window is stably controlled simply by applying the voltage on the silver plating layer and can be adjusted to a constant value. Therefore, the smart window thus manufactured is dynamically tunable. Moreover, the smart window can be switched between the chromism state and the fading state rapidly. In addition, the voltage applied on the silver plating layer is only required during a transformation between the chromism state and the fading state, and maintenance of the chromism state or the fading state by continuously applying a voltage is not required. Therefore, the smart window manufactured by the aforementioned further has an advantage of reducing energy consumption. Furthermore, in the method for manufacturing the smart window according to the disclosure, the mask layer with the etched nanospheres is formed on the transparent substrate and the conductive layer is formed through the mask layer, and thus the smart window may be manufactured rapidly on a large scale.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for manufacturing a smart window, comprising the steps of:
forming a mask layer on a surface of a transparent substrate, the mask layer comprising etched nanospheres which are not in contact with one another and which are arranged in an array;
performing a deposition treatment on the surface of the transparent substrate through the mask layer so as to form a conductive layer on the surface of the transparent substrate, the conductive layer being formed with nanopores which correspond in positions to the etched nanospheres and which partially expose the surface of the transparent substrate;
removing the mask layer so as to form a conductive composite substrate which comprises the transparent substrate and the conductive layer; and
performing a first electrochemical treatment on the conductive composite substrate so as to form a silver plating layer which covers the surface of the transparent substrate and the conductive layer, the silver plating layer comprising silver metals and silver ions, the silver plating layer configured to undergo a reduction-oxidation reaction in a second electrochemical treatment such that the silver metals are transformed into the silver ions or the silver ions are transformed into the silver metals, so as to obtain a dynamically tunable smart window.

2. The method as claimed in claim 1, wherein the conductive layer is formed using a conductive material that comprises gold, silver, aluminum, indium tin oxide, or combinations thereof.

3. The method as claimed in claim 1, wherein the etched nanospheres comprise a polystyrene nanosphere, a silicon nanosphere, or a combination thereof.

4. The method as claimed in claim 1, further comprising, before formation of the mask layer, performing an etching treatment on the surface of the transparent substrate.

5. The method as claimed in claim 1, wherein formation of the mask layer comprises:
forming a coating layer on the surface of the transparent substrate, the coating layer comprising primitive nanospheres which are in contact with one another and which are arranged in an array; and
performing an etching treatment on the coating layer so that the coating layer is formed into the mask layer.

6. The method as claimed in claim 1, wherein the mask layer is removed by using toluene.

7. The method as claimed in claim 1, wherein a thickness of the conductive layer is greater than 0 nm and not greater than 20 nm.

8. The method as claimed in claim 1, wherein the transparent substrate comprises a glass substrate or a transparent flexible substrate.

9. The method as claimed in claim 8, wherein the transparent flexible substrate comprises a polyimide film, a polyethylene terephthalate film, or a combination thereof.
